(19) United States
(12) Patent Application Publication
(10) Pub. No.: US 2007/0088634 A1
(43) Pub. Date: Apr. 19, 2007

(54) System for quality control and operations management

(75) Inventors: Kazuhiko Matsumoto, Kawasaki (JP); Toshiyuki Aritsuka, Kodaira (JP); Kei Suzuki, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/483,612

(22) Filed: Jul. 11, 2006

(30) Foreign Application Priority Data
Oct. 17, 2005 (JP) 2005-301124

(51) Int. Cl. G06Q 10/00

(52) U.S. Cl. 705/28

(57) ABSTRACT

A conventional problem with commodity quality control in a traceability system is inability to appropriately change settings for quality measurement according to environmental changes. The present invention provides a system which solves the problem and realizes real-time quality control with low power consumption. In the system for commodity quality control and operations management according to the present invention, an IC tag and a sensor node for quality measurement are attached to each commodity. The system has a mechanism for detecting either one or both of a change in the location of the commodity and a change in the work performed for the commodity. The sensor node for quality measurement can appropriately change settings for quality measurement according to a change in the location of the commodity or in the work performed for the commodity.

### CROSS-REFERENCE TO RELATED APPLICATION

This application is related to U.S. application Ser. No. 11/325,573 filed on Jan. 5, 2006, the disclosure of which is hereby incorporated by reference.

### CLAIM OF PRIORITY

The present application claims priority from Japanese application JP 2005-301124 filed on Oct. 17, 2005, the content of which is hereby incorporated by reference into this application.

### FIELD OF THE INVENTION

The present invention relates to a system for commodity quality control and operations management used in a system such as a traceability system and a supply chain. More particularly, the present invention relates to a system for commodity quality control or worker operations management performed using a sensor network.

### BACKGROUND OF THE INVENTION

As a typical example of quality control for various commodities, traceability systems for managing production and distribution histories have been increasingly employed in recent years. Particularly, in the field of foods where beef traceability has been made obligatory, the need for traceability to secure food safety has been growing.

A traceability system can manage commodity production and distribution histories covering aspects ranging from commodity production/manufacture to commodity processing, distribution and sales. Such a system requires each of the target commodities to be attached with a barcode, a two-dimensional code, or an IC tag. IC tags have internal memories into which information can be written. Furthermore, IC tags, as compared with barcodes and two-dimensional codes, can be read from a more distant location. For these reasons, use of IC tags has been on the increase. For commodity quality control, however, managing only distribution routes is inadequate. It is also necessary to measure effects of ambient conditions such as temperature and external impacts on commodities. Since IC tags themselves have no function to make such measurement, it is necessary to measure such effects on commodities using sensors, and then record and manage measurement results in forms associated with the corresponding IC tags (see Japanese Unexamined Patent Publication No. JP 2004-315154 A, for example).

### SUMMARY OF THE INVENTION

In JP 2004-315154 A, a system configuration in which commodity quality control is performed using sensors in addition to IC tags is disclosed. In the system, each commodity is attached with an IC tag and a device called a data carrier which includes a sensor and memory. The device measures ambient conditions (for example, temperature) of different locations where the commodity to which the device is attached is placed at different times and stores the measurement results. Such measurement results are read out when a transition from a stage to another occurs in a distribution process, for example, when the commodity exits a production stage and enters a conveyance stage. Thus, the system makes it possible to measure and record quality control information covering an entire course of commodity distribution. There have been however the following problems with the system.

(1) Measurement results are read out and recorded only when a stage of commodity distribution changes to a different stage. For example, even when it is feared that a commodity being transported by truck is subjected to high temperature to cause the quality of the commodity to deteriorate, whether the high temperature actually occurred or not can be known only after the commodity transportation by truck ends. Still, the system makes it possible, after the commodity having been subjected to high temperature lost its commercial value, to determine that the commodity quality deterioration occurred during transportation by truck. Furthermore, since the loss of commercial value of the commodity can be known when the transportation by truck ends, the commodity can be prevented from being sent into the subsequent stage of distribution. At any rate, however, the commodity cannot be prevented from losing its commercial value.

(2) The sensor included in a data carrier makes measurement at constant intervals. Once settings for measurement such as a measurement interval are set in a data carrier, they are maintained unless changed by a worker. In quality control, when an environmental change occurs on a commodity, for example, when the location of the commodity changes or when the content of work done for the commodity changes, conditions for quality measurement for the commodity changes. Take temperature control, for example, and assume that a perishable food to be stored at a temperature of 5° C. to 10° C. can be stored, without causing any quality problem, at a temperature above 10° C. but not exceeding 20° C. for up to one hour, or at a higher temperature not exceeding 30° C. for up to 30 minutes. When the perishable food is stored in a warehouse air-conditioned to keep internal temperature at around 8° C., it is unlikely that the temperature of the perishable food gets outside the range of 5° C. to 10° C. unless something unusual, for example, malfunction of the air-conditioner occurs. If the internal temperature of the warehouse is not expected to rapidly rise even in the event of such a malfunction of the air conditioner, measuring the temperature of the perishable food only once in 30 minutes may be adequate for quality control. However, if it is expected to take 15 minutes to take the food out of the warehouse with the outdoor temperature being 20° C. and load the food on a truck, measuring the temperature of the commodity only once in 30 minutes will not be adequate. In such a situation, it will be necessary to measure the food temperature at much shorter intervals, for example, at 1-minute intervals. Taking such a situation into account beforehand, setting the measurement interval to a minimum allowable value of 1 minute is considered to solve the problem. Since the sensor included in the data carrier is battery-driven, however, always using the minimum allowable measurement interval is inefficient in the light of power consumption, i.e. battery life, and man-hour requirement for maintenance, i.e. battery replacement work, are taken into account.

The present invention provides a system for commodity quality control and operations management which utilizes a sensor network in a system such as a traceability system or a supply chain and which makes it possible to perform real-time commodity quality control allowing condition settings for quality measurement to be appropriately changed according to an external environmental change, for example, a change in the location of a commodity or in the content of work performed for the commodity.

Furthermore, the present invention provides a system for commodity quality control and operations management which enables instructions for a work to be given to workers and target commodities for the work to be identified with ease.

A commodity quality control system according to the present invention includes sensor nodes and a management server. Each of the sensor nodes is attached to a commodity, has a sensor, and sends out data collected by the sensor. The management server stores information obtained from the sensor nodes. Each of the sensor nodes changes its state from a sleep state to an operative state in response to a first interruption caused by a clock signal or a second interruption caused by a trigger resulting from an external change. The period of the clock signal is made different between before and after the second interruption is made.

According to the present invention, by using a sensor network in a system such as a traceability system or a supply chain, qualities of commodities can be monitored in real time, locations of the commodities and contents of works done for the commodities can be grasped, and changes in the locations or in the contents of works can be detected. This makes it easy to appropriately change condition settings for quality measurement and allows workers to easily recognize the target commodities for a work to be performed.

The present invention has an effect of preventing commodity quality deterioration or enabling a quality defect, should it develop, to be detected early.

The present invention has an effect of reducing power consumption by a sensor node used for quality control. This extends the life of the battery used for the sensor node and reduces the frequency of battery replacement work.

The present invention has an effect of making it easy for a worker to recognize the target commodity for a work to be performed. This can enhance the working efficiency of the worker.

### BRIEF DESCRIPTION OF THE DRAWINGS

FIG. 1 is a diagram showing a configuration of a system for commodity quality control and operations management and a work flow;

FIG. 2 is a diagram showing a flow of processing for commodity quality control and operations management, the processing including changing settings for quality control;

FIG. 3 is a diagram showing a system configuration and a work flow according to a second embodiment;

FIG. 4 is a diagram showing a system configuration and a work flow according to a third embodiment;

FIG. 5 is a diagram showing a flow of processing for commodity quality control and operations management, the processing including summoning workers; and

FIG. 6 is a diagram showing a flow of worker summoning at a time of an accident.

### DESCRIPTION OF THE PREFERRED EMBODIMENTS

The present invention will be described in the following with reference to the accompanying drawings.

### Embodiment 1

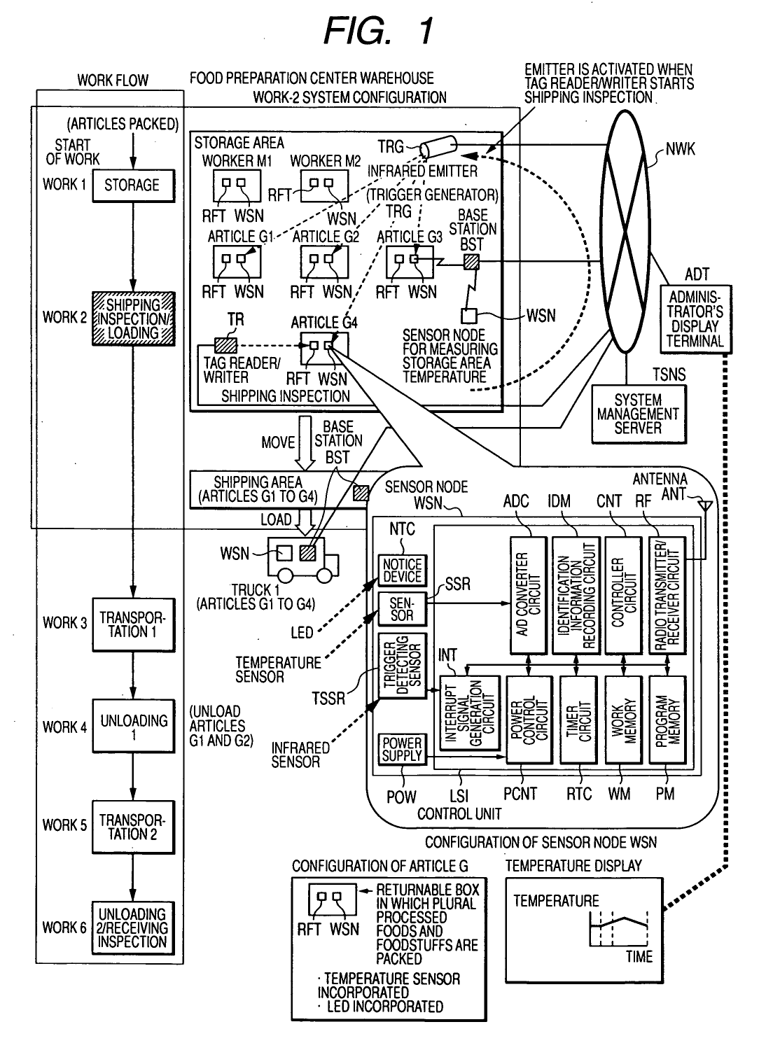

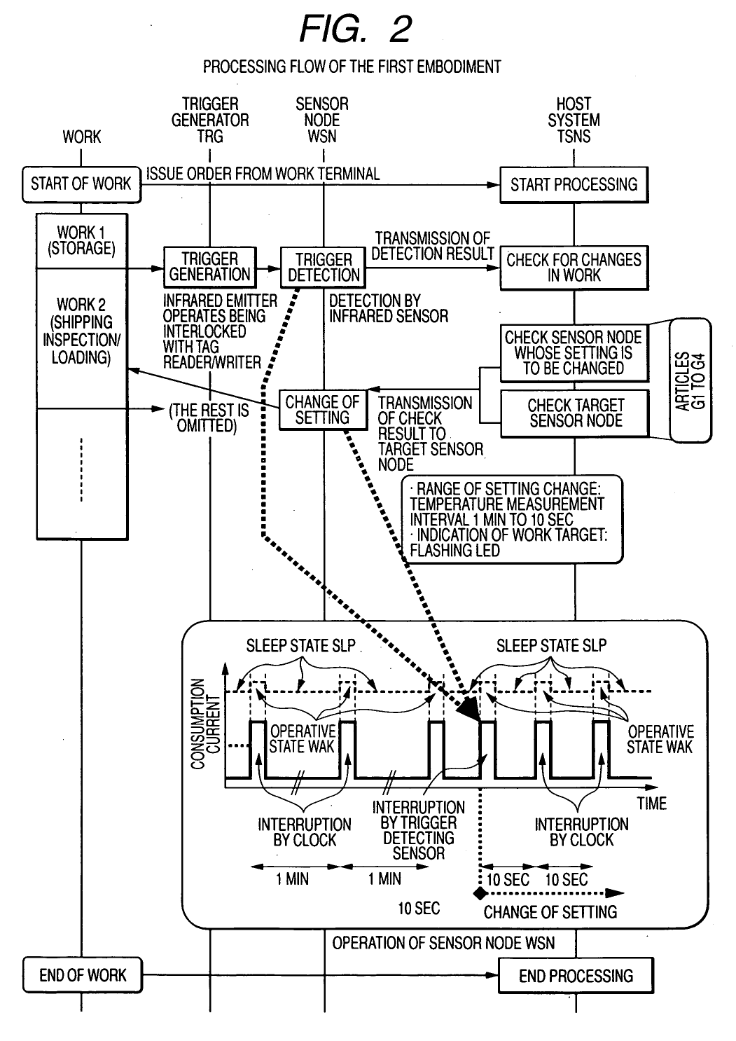

An embodiment of the present invention will be described below with reference to FIGS. 1 and 2. The present embodiment will be described based on an example system for quality control making use of a sensor network system for traceability. In the system, foods are packed in returnable boxes at a food preparation center and delivered to school or industrial feeding facilities. Quality control is effected based on temperature measurement.

FIG. 1 is a diagram showing a system configuration and a work flow according to the present embodiment. FIG. 2 is a diagram showing a flow of processing according to the present embodiment.

<System Configuration Integrating Traceability System and Sensor Network>

In the following description, unless otherwise specified, the “sensor network” refers to a “wireless sensor network” in which base stations and sensor nodes communicate wirelessly. The sensor network may, of course, be inclusive of sensor nodes which are wiredly connected to a server. The sensor network includes sensor nodes WSN each having at least one sensor attached to a commodity or person to measure a state of the commodity or person, one or more base stations BST (which may include relay stations), a sensor network management server, and an administrator terminal ADT. The base stations BST and the sensor network management server are interconnected by a network such as a LAN or the Internet.

The traceability system, on the other hand, includes IC tags RFT each of which is attached to a commodity or person to identify the commodity or person, an IC tag reader/writer RW, and a traceability management server. The tag reader/writer RW and the traceability management server LAN are interconnected by a network NWK such as a LAN or the Internet.

The present embodiment uses an integrated system in which, as shown in FIG. 1, the sensor network and the traceability system are integrated via the network NWK and which includes an integrated system management server TSNS integrating the sensor network management server and the traceability management server, and an administrator's display terminal ADT. The integrated system is configured as follows.

(TSS-1) The target commodities to be managed are returnable boxes. In each returnable box, plural foods prepared and processed at a food preparation center are packed. A returnable box is prepared for each delivery destination (school or industrial feeding facility), and foods are packed in it. In no cases, foods for plural delivery destinations are packed in a same returnable box. There are cases in which plural returnable boxes are delivered to a same delivery destination. The returnable boxes will be hereinafter referred to as the “articles”. A pair of an IC tag RFT and a sensor node WSN are attached to each article G. The IDs of the IC tag RFT and the sensor node WSN attached to each article G are related to each other beforehand, and they are managed in the integrated system management server TSNS.

(TSS-2) A pair of an IC tag RFT and a sensor node WSN are also attached to each worker M.

(TSS-3) To measure the environment of each location, such as a warehouse or a truck, where articles G are placed, a sensor node WSN is attached to the location. In the configuration shown in FIG. 1, a sensor node WSN is attached to each of the storage area of the warehouse and the truck 1.

(TSS-4) The sensor nodes WSN attached to the articles G and workers M are read by the tag reader/writer RW. Each sensor node WSN communicates with base stations BST. An adequate number of base stations BSN are installed so that data about the articles G measured by the sensor nodes WSN during a period requiring quality control to be made can be completely monitored in real time. In the system shown in FIG. 1, a base station BST is installed in each of the storage area of the warehouse, the shipping area, and the truck 1.

(TSS-5) A trigger generator TRG is installed to make the sensor nodes WSN attached to the articles G detect changes in the locations where the articles G are placed or changes in the content of work to which the articles G are subjected. The trigger generator TRG may be an infrared emitter or an electromagnetic wave generator. It is installed in a location suitable for detecting changes in the locations where the articles G are placed or changes in the content of work to which the articles G are subjected. Such a location depends on the kind of the sensor nodes WSN, that is, the kind of the trigger detection mechanism used. Details of the sensor nodes WSN to be activated by an external trigger will be described later. In the system shown in FIG. 1, an infrared emitter is installed as a trigger generator TRG on the ceiling of the storage area of the warehouse. It is necessary to determine the number of infrared emitters to be installed and the locations where they are to be installed so as to enable the sensor node WSN attached to each of the articles G placed in the storage area to detect infrared light. As being described later, the infrared emitter or emitters are to be activated when the tag reader/writer RW starts shipping inspection, and they are then required to keep emitting light for a certain amount of time.

(TSS-6) The integrated system management server TSNS incorporates application system software having various functions required according to the present invention. Such functions include, in addition to the functions for managing the sensor network and the traceability system, a function for, as described above, relating the IC tags and sensor nodes and functions for, as being described later, managing locations and operations. These functions need not necessarily be covered by one server. They may be distributed among plural servers. The functions may be executed by dedicated servers or personal computers. Namely, the kind of hardware to execute the functions is not defined.

<Sensor Node Configuration and Operation>

Next, the configuration and operation of the sensor node WSN will be described.

The sensor node WSN, as the “Configuration of sensor node WSN” in FIG. 1 shows, includes a control unit LSI providing central functions of the node, an antenna ANT for transmitting and receiving data to and from the base stations BST, a sensor SSR for inputting data from outside, and a power supply POW. The power supply POW is a primary battery, a chargeable secondary battery, a combination of a power generation device (such as a photovoltaic solar generator device, a piezoelectric generator device, or a power generation device using microwaves) and a capacitor for storing generated energy or a secondary battery, or a combination of these batteries. The LSI is connected to the antenna ANT, and includes a radio transmitter/receiver circuit RF which controls data transmission to and reception from the base stations BST, a controller circuit CNT making up a CPU (Central Processing Unit) for controlling overall LSI operation, an identification information recording circuit IDM made of a nonvolatile memory (a flash memory, for example) for recording information for identifying the sensor node WSN, an A/D converter circuit ADC for converting analog data inputted from the sensor SSR into digital data, a program memory PM which is a ROM (Read Only Memory) for recording programs, a timer circuit RTC for generating periodic signals (clock signals), and a power control circuit PCNT which adjusts the power supplied from the power supply POW to keep it at a constant voltage and which saves power by turning off the power supply POW when power is not required. The LSI need not necessarily be composed on a single chip. It may comprise multiple chips mounted on a board, or it may be an MCP (Multi-Chip Package).

To keep the sensor node in use for measurement over an extended period using limited power, it is desirable to reduce its power consumption by operating it intermittently. For this reason, the controller circuit CNT is configured, for example, such that it stops operation of the sensor SSR in a sleep state SLP and such that it then switches the sensor SSR to an operative state WAK at a prescribed timing, i.e. when interrupted by a clock signal generated by the timer circuit RTC, thereby allowing the sensor SSR to transmit data obtained by measurement.

Furthermore, according to the present invention, the configuration of each of the sensor nodes WSN attached to articles G includes, in addition to the foregoing circuits, a sensor TSSR for trigger detection and an interrupt signal generation circuit INT. The trigger detecting sensor TSSR operates independently of the sensor SSR. It is kept operative so that a trigger coming from outside can be detected any time. The trigger detecting sensor TSSR may be, for example, an infrared sensor, an illumination sensor, or a body sensor. Even though plural trigger detecting sensors may be included in the sensor node WSN, using one trigger detecting sensor per sensor node WSN is desirable to reduce power consumption. The sensors are configured to operate as follows: when the trigger detecting sensor TSSR detects a certain state, a detection signal is sent to the interrupt signal generation circuit INT; when the detection signal exceeds a certain level, the interrupt signal generation circuit INT sends an interrupt signal to the controller circuit CNT; and the controller circuit CNT then switches the sensor SSR to an operative state WAK causing measured data obtained by the sensor SSR and measured data obtained by the trigger detecting sensor TSSR to be transmitted. In cases where the trigger detecting sensor TSSR is an infrared sensor, infrared rays emitted by an infrared emitter can be used as a trigger. In cases where the trigger detecting sensor TSSR is a body sensor, detection of a body can be used as a trigger. According to the present embodiment, as shown in the “Configuration of sensor node WSN” in FIG. 1, the sensor SSR is a temperature sensor and the trigger detecting sensor TSSR is an infrared sensor.

As being described later, the sensor node WSN has a function to change the interval of its intermittent operations when, after detecting an external trigger, an order to change the interval is received from a base station.

Furthermore, the sensor node WSN has a mechanism for notifying a worker M of the location of the article G to which the sensor node WSN is attached and which is a target of a work. Such notification is made when, after detecting an external trigger, the sensor node WSN receives an order to notify the location from a base station. The mechanism may comprise a buzzer, a light emitting diode (hereinafter referred to as an “LED”), or an LCD panel. A plurality of the mechanism may be included in one sensor node WSN. In the present embodiment, as shown in FIG. 1, the sensor node attached to each article G comprises an LED which is made to flash at constant intervals during a constant period of time.

<Quality Control and Operations Management>

Next, examples of requirements for quality control and operations management will be described as supplementary or additional information.

(QC-11) The sensor node WSN attached to each article G to be a target of quality control incorporates a temperature sensor as a sensor SSR.

(QC-2) A work procedure (being described later) has been defined and inputted to the integrated system management server TSNS.

(QC-3) The sensor node WSN attached, as described in the foregoing (TSS-3), to each of the locations where articles are placed to measure the environment of each of the locations has a built-in temperature sensor SSR. As for the sensor node for measuring storage area temperature shown in FIG. 1, with the storage area being air-conditioned and being locationally fixed, there is no need to dynamically change temperature measuring conditions or to communicate the location of the target article G to any worker. The sensor node for measuring storage area temperature, therefore, includes none of the trigger detecting sensor TSSR, the interrupt generation circuit INT, and the mechanism for notifying a worker of the location of the target article G.

(QC-4) As stated in the foregoing (TSS-2), each worker M is attached with a pair of an IC tag RFT and a sensor node WSN. The sensor node WSN has a built-in temperature sensor as a sensor SSR so that it can measure work environment. The location of the worker M can be known by identifying the base station with which the sensor node WSN is communicating. Furthermore, reading the IC tag RFT using a tag reader/writer RW makes it possible to register or identify the worker being engaged in a work such as shipping inspection. The sensor node WSN described here has a configuration similar to that of the sensor node described in the above (QC-3).

Next, the work procedure mentioned in the (QC-2) will be described.

In a work procedure description, a sequence of related works are each described by the following items.

(WF-1) Work name: Name of work such as receiving inspection and transportation

(WF-2) Work No.: Number assigned to work according to the order in which the sequence of related works are carried out.

(WF-3) Work time schedule: Scheduled work starting time and work ending time

(WF-4) Worker in charge: Name of worker in charge. In cases where the worker bears a sensor node WSN and/or an IC tag RFT, their IDs.

(WF-5) Equipment and devices to be used: Names of equipment and devices used for the work, for example, hand truck, truck, tag reader, etc. In cases where such equipment and devices are attached with sensor nodes WSN and/or IC tags RFT, their IDs.

(WF-6) Target article G (ID of IC tag RFT) and method of directing worker: ID of the IC tag RFT attached to each article handled as a direct target of work, and method of giving directions from sensor nodes to the worker.

(WF-7) Locations of target article G: Locations where the target article is placed before work is started and after work is finished. At least one base station BST is installed at each of the locations. The base station and the location where it is installed are associated with each other.

(WF-8) Setup parameter (for each sensor node WSN attached to article G): ID and setup parameter of each of the sensor nodes attached to direct target articles and each of the sensor nodes attached to related articles. For each sensor used to measure temperature or humidity, the measurement interval (interval of intermittent measurement operations) is defined by a setup parameter. When a work is to unload some of the articles loaded on a truck, the articles to be unloaded are referred to as direct target articles, and the articles to be left on the truck are referred to as related articles.

(WF-9) ID of sensor node for environmental measurement: ID of the sensor node WSN for environmental measurement installed at a work site

(WF-10) Work content: Content of work

These contents of each work procedure are associated, in the integrated system management server TSNS, with IDs of IC tags RFT and sensor nodes WSN. The contents of each work procedure can be displayed on an administrator's display terminal ADT.

In the following, an embodiment of quality control and operations management will be described in detail with reference to the work flow shown in FIG. 1 and the work change detection flow shown in FIG. 2.

First, the contents of each work procedure will be described. Each work procedure covering different works to be carried out is defined as follows.

(WF1-1) Work name: Work 1 (Storage)

(WF1-2) Work No.: 1

(WF1-3) Scheduled work time: Starting time=09:10, Sep. 1, 2005; ending time=09:20, Sep. 1, 2005

(WF1-4) Workers in charge: None

(WF1-5) Equipment and devices to be used: None

(WF1-6) Location of target article G: When work is started=storage area of warehouse; when work is finished=storage area of warehouse

(WF1-7) Target articles G: G1 (ID=0001), G2 (ID=0002), G3 (ID=0003), and G4 (ID=0004)

(WF1-8) Setup parameters: Temperature measurement interval=1 minute for G1 (ID=0001), 11 minute for G2 (ID=0002), 1 minute for G3 (ID=0003), and 1 minute for G4 (ID=0004)

(WF1-9) ID of sensor node for environmental measurement: ID of the sensor node for measuring storage area temperature=1001

(WF1-10) Work content: Storing articles in the storage area of a warehouse

(WF2-1) Work name: Work 2 (Shipping inspection/Loading)

(WF2-2) Work No.: 2

(WF2-3) Scheduled work time: Starting time=09:20, Sep. 1, 2005; ending time=09:40, Sep. 1, 2005

(WF2-4) Workers in charge: M1 (ID=2001) and M2 (ID=2002)

(WF2-5) Equipment and devices to be used: Hand truck 1, tag reader/writer 1, and truck 1

(WF2-6) Location of target article G: When work is started=storage area of warehouse; when work is finished=in the box of truck 1 (Location of the truck 1 is the shipping area of the warehouse.)

(WF2-7) Target articles G: G1 (ID=0001, LED flashing), G2 (ID=0002, LED flashing), G3 (ID=0003, LED flashing), and G4 (ID=0004, LED flashing),

(WF2-8) Setup parameters: Temperature measurement interval=10 seconds for G1 (ID=0001), 10 seconds for G2 (ID=0002), 10 seconds for G3 (ID=0003), and 10 seconds for G4 (ID=0004)

(WF2-8) IDs of sensor nodes for environmental measurement: ID of the sensor node for measuring storage area temperature=S101; ID of the sensor node for measuring temperature in the box of truck 1=S102

(WF2-9) Work content: (1) Loading articles on hand truck 1 in the storage area of the warehouse, and moving them to the shipping area; (2) Inspecting the articles for shipping using tag reader/writer 1; (3) Loading the articles on truck 1

The work procedure up to work 2 has been described above. Description of work 3 (transportation 1), work 4 (unloading 1), work 5 (transportation 2) and work 6 (unloading 2) will be omitted as a matter of convenience.

Next, with reference to the processing flow shown in FIG. 2, concrete contents of the processing will be described.

First, when an order to start work is issued from a work terminal ADT, a host system (integrated system management server TSNS) recognizes starting of the work. The time the work is started is when foodstuffs for use at feeding facilities have been packed in articles (returnable boxes) G1 to G4 and placed in a storage area. When that state occurs, work 1 (storage) is started. The temperature measurement interval of each of the sensor nodes attached to the articles G1 to G4 placed in the storage area is 1 minute as specified in (WF1-8).

Next, recognition of a change (transition) from work 1 (storage) to work 2 (shipping inspection/loading) and relevant processing will be described. Worker M1 (or M2) prepares a tag reader/writer 1, and issues an order to start shipping inspection from a work terminal ADT. Responding to the order, the integrated system management server TSNS activates a trigger generator TRG (that is, in the present example, an infrared emitter installed in the storage area) which has been set to be activated when an order to start the storage work is issued. The sensor node WSN attached to each of the articles G1 to G4 placed in the storage area detects a trigger (infrared rays) emitted by the infrared emitter using a trigger detecting sensor TSSR. As a result, the sensor node WSN that has been in a sleep state SLP enters an operative state WAK. Hereinafter, description will focus on the article G1 as a representative article. The sensor node WSN having entered an operative state WAK transmits a result of infrared detection (as well as a result of temperature measurement) to the base station BST in the storage area. The base station BST transmits the result information thus received to the integrated system management server TSNS. As the data transmitted from the sensor node with ID S001 includes a result of infrared detection, the integrated system management server TSNS conducts a check to see if a work change (transition) occurred. In this case, with the order to start shipping inspection having been issued, the change from work 1 to work 2 can be confirmed. The integrated system management server TSNS then checks to see if the sensor node with ID S001 is the sensor node whose setting is to be changed as a result of the work change (transition). As the sensor node with ID S001 corresponds to an IC tag with ID 0001 and the setup parameter G1 (ID=0001) specified in the (WF2-8) for the work procedure specifies a temperature measurement interval of 10 sec., it can be known that the sensor node with ID S001 is the sensor node whose setting is to be changed and that the temperature measurement interval of the sensor node requires to be changed to 10 sec. Furthermore, whether the sensor node is a target of the work is checked. In this case, it can be confirmed that the target articles G specified in the (WF2-7) for the work procedure includes G1 (ID=0001) and that the LED attached to the article G1 is to be flashed. Based on the results of these checks, the integrated system management server TSNS gives a response to the base station BST. The response orders the base station BST to issue two orders to the sensor node with ID S001, one being for changing the setup parameter, that is, for changing the temperature measurement interval to 10 sec. and the other being for flashing the LED. The base station BST conveys the response received from the integrated system management server TSNS to the sensor node with ID S001 as an acknowledge signal (ACK). Responding to the acknowledge signal received from the base station BST, the sensor node with ID S001 changes, as ordered, its temperature measurement interval to 10 sec. and flashes the LED. The same checks as done for the article G1 are also conducted for the articles G2 to G4, causing their temperature measurement intervals to be changed to 10 sec. and LEDs to be flashed. The workers M1 and M2 select the articles with a flashing LED and inspect them for shipping. The workers M1 and M2 then load the articles G1 to G4 they inspected for shipping on a hand truck 1, transport the articles G1 to G4 loaded on the hand truck 1 to the shipping area, and load them on a truck 1. Closing the back doors of the truck 1 after loading the articles G1 to G4 ends the work 2.

Quality control and operations management (supporting) can be performed by repeating the above processing that includes changing the temperature measurement interval of each sensor node WSN and flashing the LED attached to each sensor node WSN every time a transition from a work to another occurs.

In the present embodiment, IC tags RFT and sensor nodes WSN are used in pairs, each pair comprising an IC tag RFT and a sensor node WSN. An IC tag is a passive device which does not require such maintenance as changing a battery. Therefore, when an article, which is a returnable box, is to be used over and over again, an IC tag can be kept attached to the returnable box. As for a sensor node, however, it may become necessary to replace the battery loaded therein. It is therefore assumed that the sensor node is, without being kept attached to a returnable box, attached to the returnable box as required. Needless to say, there may also be cases where, depending on the application, the IC tag and the sensor node may both be left attached to a returnable box. Furthermore, it is also possible to carry out quality control and operations management by attaching only a sensor node to each returnable box without attaching any IC tag to the returnable box.

### Embodiment 2

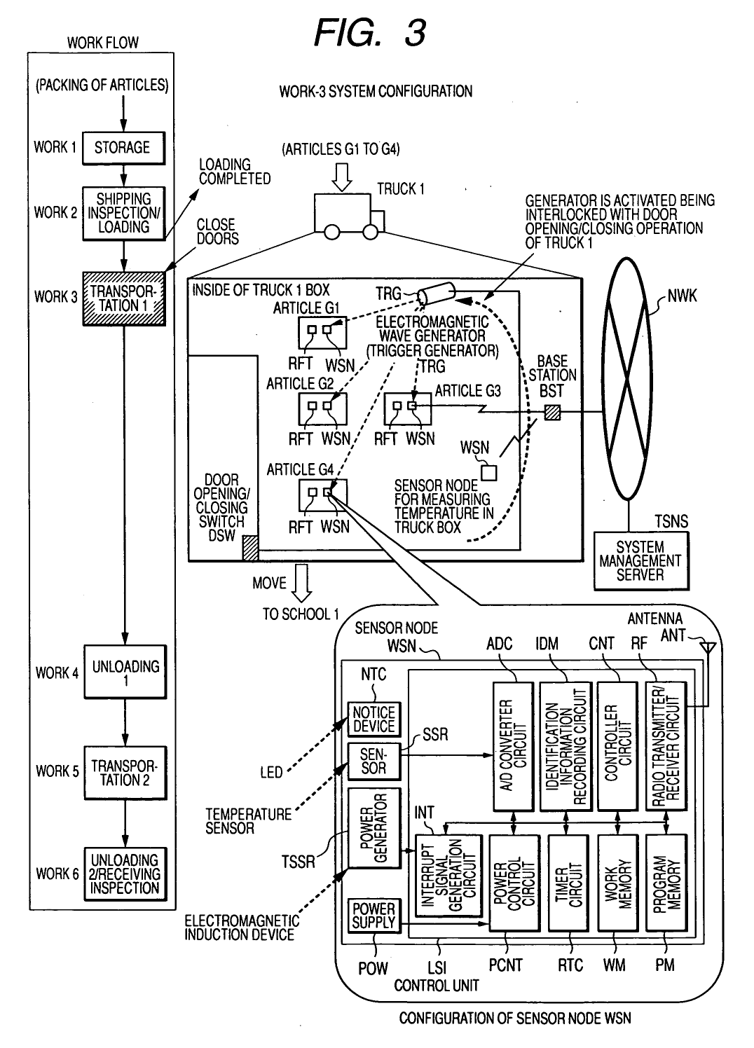

An application of a sensor node having a trigger detecting sensor TSSR has been described as the first embodiment. In the following, an application of a sensor node which is activated by a power generator will be described as a second embodiment. In FIG. 3, an example configuration of a sensor node WSN having a power generator is shown. The configuration of the sensor node WSN shown in FIG. 3 includes a power generator IND instead of the trigger detecting sensor TSSR included in the configuration of the sensor node WSN shown in FIG. 1. The power generator IND operates independently of the power supply POW. The power generator IND may comprise an electromagnetic induction coil or solar cells. The output voltage of the power generator IND is sent to the interrupt signal generation circuit INT. When the output voltage exceeds a certain level, the interrupt signal generation circuit INT sends an interrupt signal to the controller circuit CNT. This causes the sensor SSR to be switched into an operative state WAK and to send out measured data and electromotive voltage data. In cases where the power generator IND includes an electromagnetic induction coil, it may be configured to generate electromagnetic induction when subjected to, for example, a 2-GHz electromagnetic wave so that the 2-GHz electromagnetic wave may be used as an external trigger. In cases where the power generator IND includes solar cells, visible light exceeding certain brightness can be used as a trigger.

FIG. 3 shows a system configuration and a work flow of the second embodiment. The work flow shown in FIG. 3 is the same as the work flow shown in FIG. 1. They are made the same for convenience of explanation, but the systems of the first and the second embodiments are different. For the second embodiment, detection of a change from work 2 (shipping inspection/loading) to work 3 (transportation 1) and relevant processing will be described below.

A pair of an IC tag RFT and a sensor node WSN are attached to each of the articles G1 to G4 as in the first embodiment. What differs from the first embodiment is that the sensor node WSN has an electromagnetic inductor as a power generator IND.

At least one electromagnetic wave generator is installed as a trigger generator TRG in the box of a truck 1. Its operation is interlocked with a door opening/closing switch DSW attached to the back doors of the truck 1. Namely, every time the back doors of the truck 1 open or close, the electromagnetic wave generator emits an electromagnetic wave for a constant period of time. It is necessary to determine the number of the electromagnetic wave generators to be installed in the box of the truck 1 and how to install them (as to the emission direction, etc.) so that the sensor node attached to each of the articles placed in the box of the truck 1 can be activated by electromagnetic waves emitted by them. A base station BST to monitor measurements taken by the sensor nodes located in the truck is also installed in the box of the truck 1. The base station BST can wirelessly access a network NWK even while the truck is traveling.

The work procedure for up to work 2 is the same as used in the first embodiment. The procedure for work 3 (transportation 1) is defined as follows.

(WF3-1) Work name: Work 3 (Transportation 1)

(WF3-2) Work No.: 3

(WF3-3) Scheduled work time: Starting time=09:40, Sep. 1, 2005; ending time=10:10, Sep. 1, 2005

(WF3-4) Worker in charge: Driver M3 (ID=2003)

(WF3-5) Equipment and devices to be used: Truck 1

(WF3-6) Location of target articles G: When work is started=in the box of truck 1 (the truck 1 is located in the shipping area of the warehouse); when work is finished=in the box of truck 1 (the truck 1 is located in school 1)

(WF3-7) Target articles G: G1 (ID=0001), G2 (ID=0002), G3 (ID=0003), and G4 (ID=0004)

(WF3-8) Setup parameters: Temperature measurement interval—1 minute for G1 (ID=0001), 1 minute for G2 (ID=0002), 1 minute for G3 (ID=0003), and 1 minute for G4 (ID=0004)

(WF3-9) ID of sensor node for measuring temperature in truck 1=S102

(WF3-10) Work content: Transporting articles from the warehouse of a food preparation center to school 1 using truck 1

In the foregoing description of the first embodiment, it was stated that closing the back doors of the truck 1 after loading the articles G1 to G4 ends the work 2. In the present embodiment, the procedure advances from work 2 to work 3 when the back doors of the truck 1 are closed. As previously stated, at least one electromagnetic wave generator is installed in the box of the truck 1 as a trigger generator TRG which operates being interlocked with the opening/closing of the back doors of the truck 1. When the back doors of the truck 1 are closed, the electromagnetic wave generator is activated. As a result, in each of the sensor nodes WSN attached to the articles G1 to G4 placed in the box of the truck 1, the power generator IND is activated by electromagnetic induction. This causes an interrupt signal to be generated and the sensor node WSN that has been in a sleep state SLP to enter an operative state WAK. Hereinafter, description will focus on the article G1 as a representative article. The sensor node WSN having entered an operative state WAK transmits a result of power generation (as well as a result of temperature measurement) to the base station BST in the box of the truck 1. The base station BST transmits the result information thus received to the integrated system management server TSNS. As the data transmitted from the sensor node with ID S001 includes a result of power generation, the integrated system management server TSNS conducts a check to see if a work change (transition) occurred. It is known to the integrated system management server TSNS that the sensor node with ID S001 was, until just before, in a state in which the work 2 was being carried out. For the work 2 to be finished, shipping inspection requires to have been finished. It is assumed here that completion of the inspection work has been recognized. Next, it is confirmed that all of the articles G1 to G4 are loaded on the truck 1. This confirmation can be made by having the base station BST (ID=1002) in the box of the truck communicate with the articles G1 to G4. The confirmation made in this way can also confirm the location for work 3. That is, the box of the truck 1 in which the base station BST communicated with the article G1 coincides with the location (box of the truck 1) where the sensor node with ID S001 attached to the article G1 is required to be when the work 3 is started. It would be more preferable if the location of the truck 1 could also be confirmed at the same time. Considering that the back doors of the box of the truck 1 were closed just before, it can be considered most certain that the truck 1 is located in the shipping area of the warehouse of the food preparation center. It is of course possible to more reliably determine the location of the truck 1, for example, by using GPS (Global Positioning System). After it is confirmed that the procedure has advanced from work 2 to work 3, it is checked whether the sensor node with ID S001 is the sensor node whose setting is to be changed as a result of the work change (transition). As the sensor node with ID S001 corresponds to an IC tag with ID 0001 and the setup parameter G1 (ID=0001) specified in the (WF3-8) for the work procedure specifies a temperature measurement interval of 10 min., it can be known that the sensor node with ID S001 is the sensor node whose setting is to be changed and that the temperature measurement interval of the sensor node requires to be changed to 1 min. Furthermore, whether the sensor node is a target of the work is checked. In this case, it can be confirmed that the target articles G specified in the (WF3-7) for the work procedure includes G1 (ID=0001). Based on the results of these checks, the integrated system management server TSNS gives a response to the base station BST. The response orders the base station BST to issue an order to the sensor node with ID S001 to change the temperature measurement interval to 1 min. The base station BST conveys the response received from the integrated system management server TSNS to the sensor node with ID S001 as an acknowledge signal (ACK). Responding to the acknowledge signal received from the base station BST, the sensor node with ID S001 changes, as ordered, its temperature measurement interval to 1 min. The same checks as done for the article G1 are also conducted for the articles G2 to G4, causing their temperature measurement intervals to be changed to 1 min. The driver M3 driving the truck 1 heads for school 1.

An application of a sensor node which is activated by a power generator has been described above.

Examples of quality control made using a sensor network system for traceability have been described based on the two embodiments. According to the two embodiments, in transporting foods from a food preparation center, both power saving and meticulous quality control can be realized by using a sensor network system for traceability, measuring temperature, and changing the temperature measurement interval according to the content of work to be performed. Such a system can also provide wok support, for example, by flashing LEDs attached to the articles to be handled in the work.

### Embodiment 3

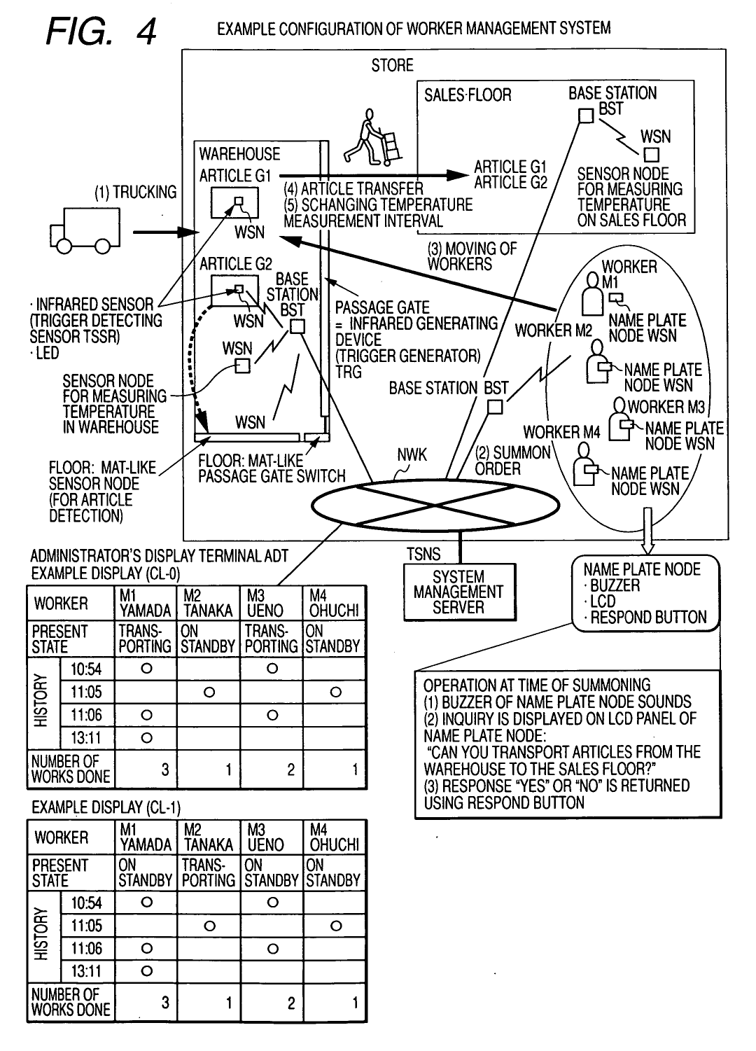

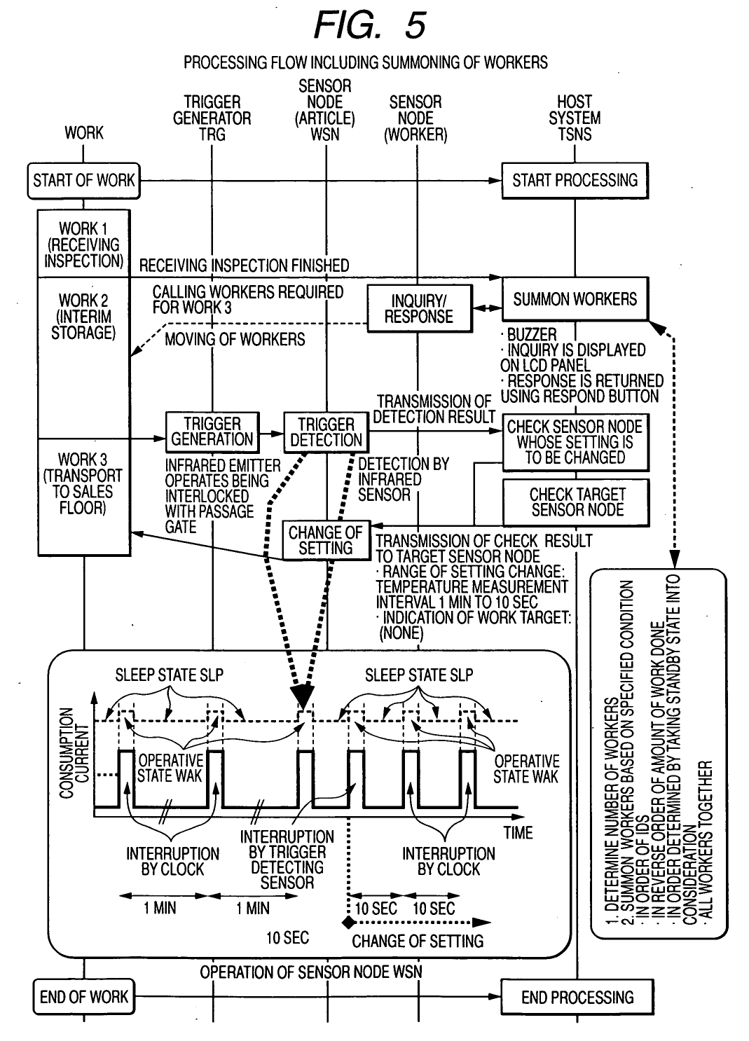

Next, an embodiment of worker management will be described with reference to FIGS. 4 and 5.

FIG. 4 is a diagram showing a system configuration of the present embodiment and the content of work. FIG. 5 is a diagram showing a processing flow of the present embodiment.

First, an outline of the present embodiment will be described. In the present embodiment, articles transported by truck to a warehouse are transferred from the warehouse to a sales floor of a store by plural workers. The articles are subjected to quality control based on temperature measurement. The work procedure is as follows.

(1) When article transportation by truck is finished, an order to transport the articles is issued to workers.

(2) Depending on the number and nature (for example, as to weight and expensiveness) of the articles, an appropriate number of workers are summoned.

During the work, the interval for measuring the temperature of the articles being transported is dynamically changed so that rapid temperature changes can be monitored without delay.

The system configuration of the present embodiment as shown in FIG. 4 is similar to those of the first and the second embodiments. Namely, the system includes an integrated system management server TSNS, an administrator terminal ADT, one or more sensor nodes WSN each having a sensor, one or more base stations BST (which may include relay stations), and a trigger generator TRG. The integrated system management server TSNS, the administrator terminal ADT, the base station BST, and the trigger generator TRG are interconnected by a network NWK.

A more concrete description of the system configuration will follow.

(SHS-1) Articles G are packed in cardboard boxes. A sensor node WSN is attached to each of the articles G. The ID of the sensor node WSN attached to each article is registered with and managed in the integrated system management server TSNS. Each of the sensor nodes WSN attached to the articles G incorporates a temperature sensor as a sensor SSR and an infrared sensor as a trigger detecting sensor TSSR.

(SHS-2) Each worker M bears a sensor node WSN as a nameplate. The sensor node WSN used as a nameplate will be hereinafter referred to as a nameplate node. The nameplate node has a sensor SSR which is a temperature sensor and a respond button which can be used to send out a response “YES” or “NO.” It also has a buzzer and an LCD display LCD which are used to give a notice to the worker M. A short massage can be displayed on the LCD display LCD.

(SHS-3) A sensor node WSN incorporating a temperature sensor as a sensor SSR is installed in the warehouse and also on the sales floor to measure temperature at locations where the articles are placed.

(SHS-4) Mat-like sensor nodes WSN are installed on the floor of the warehouse where the articles having been unloaded from a truck and having undergone receiving inspection are temporarily stored. The sensor nodes WSN each have a sensor SSR which is a switch for detecting placement of articles on the warehouse floor. To detect placement of articles on the warehouse floor without fail, the number of the sensor nodes WSN to be installed is determined based on the area of the warehouse floor.

(SHS-5) A gate provided with an infrared emitter as a trigger generator TRG is installed at the exit of the warehouse so that the sensor nodes WSN attached to the articles G can detect conveyance of the articles G out of the warehouse. A mat-like switch for the infrared emitter is installed on a floor portion in front of the exit. When a person steps on the mat-like switch or when any object is placed on it, the switch turns on to cause the infrared emitter to emit infrared light for a certain period of time.

(SHS-6) The integrated management server TSNS incorporates application system software having various functions required according to the present invention such as sensor network management functions and operations management functions.

Next, the processing flow shown in FIG. 5 will be described.

First, when an order to start work is issued from a work terminal ADT, a host system (integrated system management server TSNS) recognizes starting of the work. The time the work is started is when the truck has arrived at the store and the articles G1 and G2 have been unloaded. When that state occurs, work 1 (receiving inspection) is started. The temperature measurement interval of each of the sensor nodes attached to the articles G1 and G2 is 10 seconds. It is when the receiving inspection is finished and the articles G1 and G2 are placed in a temporary storage area that work 2 is started. Starting of the work 2 can be recognized by having the sensor node WSN installed in the temporary storage area detect placing of articles there. When starting of the work 2 is recognized, the temperature measurement interval of each of the sensor nodes attached to the articles G1 and G2 is changed to 1 minute. This is done in a manner similar to that described for the first embodiment, though detailed description is omitted here. At the same time as the work 2 is started, workers for transporting the articles to the sales floor in work 3 are summoned.

It is now assumed that, based on information about the receiving inspection conducted in the work 1, the integrated system management server TSNS already recognizes that the number of workers required to carry out the work 3 is two. It is also assumed that, in the store, there are four workers M1 (sensor node ID=3001) to M4 (sensor node ID=3004). In this situation, worker summoning is done as follows.

The integrated system management server TSNS sends, via the base station BST installed on the sales floor, an inquiry “Can you transport articles from the warehouse to the sales floor?” to the nameplate node WSN of each of the workers (ID=3001 to ID=3004) one by one in order of ID number. First, the inquiry is sent to the worker M1 (ID=3001). This causes the buzzer of the nameplate node WSN of the worker M1 to sound and the inquiry to be displayed on the LCD display LCD included in the nameplate node WSN. The worker M1 returns a response “YES” or “NO” using the respond button of the nameplate node. Now, assume that the response returned by the worker M1 is “YES.” The integrated system management server TSNS having received the response from the worker M1 sends the same inquiry to the worker M2 (ID=3002). Now, assume that the worker M2 returns a response “NO.” Since the number of workers required to carry out the work 3 is two, the integrated system management server TSNS having received the response from the worker M2 sends the same inquiry to the worker M3 (ID=3003). Now, assume that the worker M3 returns a response “YES.” This time, with the number of workers having returned a response “YES” having totaled two, i.e. the number of required workers, the integrated system management server TSNS ends sending out the inquiry. The workers M1 and M2 having sent out their responses “YES” move to the warehouse. Information on the working state, including a past work history, of each worker is displayed on the display terminal ADT (CL-0). In the present example, the workers M1 (Yamada) and M3 (Ueno) are displayed as being engaged in transportation. The workers M2 (Tanaka) and M4 (Ohuchi) are displayed as being on standby.

When the above state is reached, summoning of the workers to be carried out during the work 2 (storage) ends. The next work to be carried out is to transport the articles G1 and G2 to the sales floor. The workers M1 and M2 load the articles G1 and G2 on a hand truck and move them to the store via the exit of the warehouse. In the present example, the time when the articles G1 and G2 leave the warehouse through the exit is regarded as the time when the work 3 (article transportation) starts. When the articles G1 and G2 pass through the exit of the warehouse, the switch installed on the floor portion in front of the exit makes the infrared emitter installed at the exit as a trigger generator TRG emit infrared light. The sensor node WSN attached to each of the articles G1 and G2 detects, using the trigger detecting sensor TSSR incorporated therein, the trigger (infrared light) emitted by the infrared emitter. As a result, the sensor node WSN that has been in a sleep state SLP enters an operative state WAK. The subsequent operation is the same as described for the first embodiment, so that details of the subsequent operation will be omitted here. The temperature measurement interval of the sensor node WSN attached to each of the articles G1 and G2 is changed from 1 min. to 10 sec. The work 3 ends when the articles are transported to the sales floor and unloaded from the hand truck.

The above embodiment is an example in which, in addition to quality control, worker summoning is carried out as part of worker management. Even though, in the above embodiment, workers are summoned in order of their ID (CL-0), they may be summoned in different orders, examples of which are described below.

(CL-1) Workers are summoned in the order determined according to the amount of work done by them in the past. To use this method, a work history of each worker is stored and workers are summoned in reverse order of the amount of work done by them in the past. In the case of the example (CL-1) displayed on the display terminal ADT shown in FIG. 4, workers are summoned in reverse order of the number shown in the “number of works done” field, that is, in the order of M2 (Tanaka, 1 work), M4 (Ohuchi, 1 work), M3 (Ueno, 2 works), and M1 (Yamada, 3 works).

(CL-2) The above method (CL-1) does not take into consideration the current state of each worker, so that workers currently being engaged in a work may possibly be summoned. To avoid such a situation, workers being engaged in a work may be precluded. Namely, M4 (Ohuchi, 1 work), M3 (Ueno, 2 works), and M1 (Yamada, 3 works) are summoned in this order, with M2 (Tanaka, 1 work) currently being engaged in transportation exempted.

It is also possible to use a base station communicating with nameplate nodes of workers to grasp the locations of the workers and summon the workers in order of their nearness to a work site. Thus, the order in which to summon workers can be determined flexibly depending on the situation.

### Embodiment 4

An example procedure which can be used in the event of an accident occurring while articles are in storage in the third embodiment will be described as a fourth embodiment. It is assumed here that the articles G1 and G2 are required to be kept at a temperature of 5° C. to 15° C. and that they are not allowed to be kept at 15° C. or higher temperature for longer than 10 minutes. When they are kept at 15° C. or higher temperature for longer than two minutes, all workers are summoned to the warehouse to take a countermeasure.

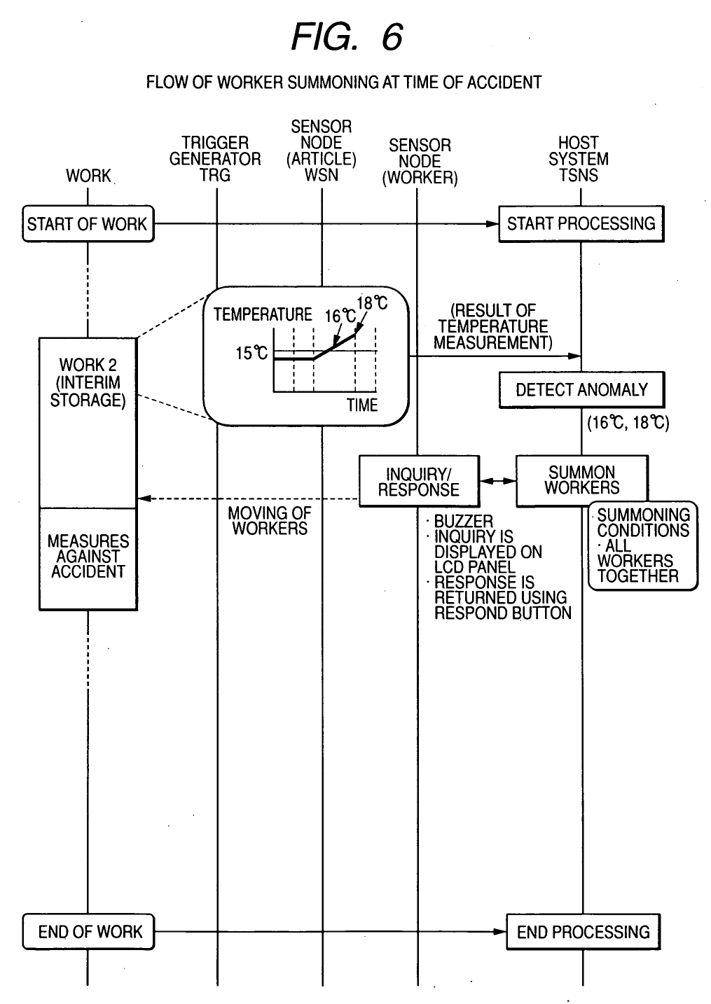

FIG. 6 is a diagram showing a flow of worker summoning at a time of an accident. The following description is based on FIG. 6. It is assumed that the articles G1 and G2 are in temporary storage (work 2). Each of the articles G1 and G2 is measured by the temperature sensor included in the attached sensor node WSN at 1-minute intervals. The measured data are sent to the integrated system management server TSNS in real time. Now, assume that temperatures of 16° C. and 18° C. were successively read on the article G1, meaning that the temperature measurement on the article G1 exceeded 15° C. twice in succession. Complying with a rule requiring workers to be summoned to take a countermeasure when the temperature of an article exceeds 15° C. for longer than two minutes, the integrated system management server TSNS sends an instruction message reading “An accident occurred on articles in storage, come to the warehouse” to all workers, i.e. M1 to M4, at a time. This causes the buzzer of the nameplate node attached to each of the workers M1 to M4 to sound and the above message to be displayed on the LCD display LCD of the nameplate node. Each of the workers returns a response “YES” and heads for the warehouse, unless he or she is engaged in work which cannot be suspended. The workers who have gathered at the warehouse take a countermeasure against the accident.

The above embodiment is an example of summoning workers at a time of an accident making use of nameplate nodes in a system in which quality control information and operations management are interrelated.

As described for the third and the fourth embodiments, using nameplate nodes makes it possible to grasp current states and locations of workers and summon them, while taking into consideration the states of the articles being quality controlled. The nameplate nodes can also be made use of to give instructions to workers to allocate them to plural work sites.

The present invention relates to commodity quality control and management of workers' operations. Particularly, the present invention is applicable to systems for quality control and work support.

What is claimed is:

1. A quality control system for commodities, comprising:
at least one sensor node which is attached to a commodity, which has at least one sensor, and which transmits data collected by the sensor; and
a management server which stores information obtained from the sensor node,
wherein the sensor node changes a state thereof from a sleep state to an operative state responding to one of a first interruption caused by a clock signal and a second interruption caused by a trigger resulting from an external change, and
wherein a period of the clock signal is made different between before and after the second interruption is made.

2. The quality control system according to claim 1, wherein the sensor node has a trigger detecting sensor which detects a prescribed external change.

3. The quality control system according to claim 1, wherein the sensor node has a power generation mechanism which detects a prescribed external change.

4. The quality control system according to claim 1, further comprising a mechanism for notifying a worker of, out of plural articles, a target article of a work.

5. The quality control system according to claim 4, further comprising a mechanism for selecting and summoning one or more workers to be in charge of the target article of the work.

6. The quality control system for commodities according to claim 4, wherein the mechanism for notifying the worker of the target article of the work notifies the worker by doing one of the following operations:
flashing a light emitting diode included in the sensor node attached to the article;
displaying a target article indication on a liquid crystal display included in the sensor node;
sounding a buzzer included in the sensor node;
displaying a location of the target article on a display terminal held by the worker;
displaying the location of the target article on a display terminal installed near the location; and
doing a combination of two or more of the above operations.

7. The quality control system according to claim 5, wherein the mechanism for notifying the worker of the target article of the work notifies of a work procedure to be used for the target article.
